(19) United States
(12) Patent Application Publication
(10) Pub. No.: US 2019/0333706 A1
(43) Pub. Date: Oct. 31, 2019

(54) Can for Electrolytic Capacitor

(71) Applicant: EPCOS AG, München (DE)

(72) Inventors: Róbert Bösze, Tanakajd (HU); Tamás Lakatár, Köszeg (HU); Naoki Sakura, Szombathely (HU); Ottó Klug, Szombathely (HU); László Gál, Magyarkanizsa (RS); Achim Müller, Zöschingen (DE)

(21) Appl. No.: 16/085,917

(22) PCT Filed: Mar. 15, 2017
(86) PCT No.: PCT/EP2017/056156

§ 371 Date: Sep. 17, 2018

(30) Foreign Application Priority Data
Mar. 17, 2016 (DE) 10 2016 104 988.3

(51) Int. Cl. H01G 9/12; H01G 9/145

(52) U.S. Cl. CPC H01G 9/12; H01G 9/0003; H01G 9/145

(57) ABSTRACT

A can for an electrolytic capacitor is disclosed. In an embodiment a can for an electrolytic capacitor includes a bottom including a first area and a second area, wherein the first area is recessed relative to the second area at an outer surface of the bottom of the can.

This patent application is a national phase filing under section 371 of PCT/EP2017/056156, filed Mar. 15, 2017, which claims the priority of German patent application 10 2016 104 988.3, filed Mar. 17, 2016, each of which is incorporated herein by reference in its entirety.

### TECHNICAL FIELD

The present invention relates to a can for an electrolytic capacitor. The base material of the can may be aluminum or an aluminum alloy, for example.

### BACKGROUND

Chinese Utility Models CN 204 029 609 U and CN 202 363 266 U disclose electrolytic capacitors comprising a casing, wherein an internal bottom part of the casing is provided with a reinforcing rib. European Patent Application EP 0 120 971 A1 discloses an electrolytic capacitor comprising a can with a safety vent.

### SUMMARY OF THE INVENTION

Embodiments provide an improved can for an electrolytic capacitor.

In one aspect, embodiments of the present invention relate to a can for an electrolytic capacitor. The can has a bottom comprising a first area and a second area, wherein the first area is recessed relative to the second area at an outer surface of the bottom. Accordingly, the geometric design of the first and second area is visible from outside.

The can may have the shape of a circular cylinder, which is closed at one end by the bottom. At the opposite end, the can may comprise an opening for placing a capacitor element in the can. As a base material, the can may comprise aluminum or an aluminum alloy, for example.

During operation of the capacitor, pressurization inside the can may occur, caused by electrochemical reactions. Thereby, the can is set under mechanical stress. This may lead to the can being deformed, for example, bulged or elongated. Mechanical deformation of this kind may have several negative effects on capacitor properties like overall component length increase, less vibration stability and degrading thermal dissipation properties during the life time of the component.

The recessed arrangement of the first area relative to the second area may mechanically stabilize the can. Due to the recessed arrangement, bulging of the first area may not result in an overall bulging of the can. In particular, the geometry may be such that the bulging of the first area may occur within the outer dimensions set by the second area. In other words, the first area does not protrude outwards beyond the second area even when bulging of the first area occurs.

The second area may have a higher resistance to pressure than the first area. Accordingly, when pressurization inside the can occurs, the second area will deform less than the first area. Due to the high resistance to pressure of the second area, the overall resistance to pressure of the bottom may be increased.

In an embodiment, the first area has a first thickness and the second area has a second thickness, wherein the second thickness is greater than the first thickness. As an example, the thickness of the second area may be at least 1.5 times the thickness of the first area. The thickness of the first area may be at least the thickness of the lateral area of the can.

In an embodiment, the first area may be plain with the second area at an inner surface of the bottom. In particular, the first area may be non-discernable from the second area inside the can. Thereby, the geometric design of the bottom does not affect the interior properties of the can.

In an embodiment, the second area may laterally enclose the first area. The second area may be located nearer to the lateral edge of the bottom than the first area. The first area may be located in a central part of the bottom.

The design of the first and second area may be such that an overall bulging of the can at high inner pressure, in particular of the can bottom, is reduced or does not occur at all. In particular, bulging of the outer surface of the can bottom should be prevented. In other words, the outer surface of the second area should remain plain also at increased inner pressure. As an example, the second area may fully enclose the first area. In particular, the can bottom may have a higher thickness in its lateral edge region, which corresponds to the second area, than in its central region, which corresponds to the first area.

The second area may encircle the first area without any gaps. A gap in the second area, e.g., a region with reduced thickness in the second area, may lead to an overall bulging of the can bottom. In case that such a gap exists, the second area may not remain plain at an increased pressure but may become uneven because bulging may occur due to such gaps. A gapless geometry of the second area results in a high mechanical robustness.

In an embodiment, the second area may have the shape of a circular ring. The second area may extend up to the edge of the bottom. The first area may have the shape of a circular disk. The circular disk may be enclosed by the second area in the shape of a circular ring. Accordingly, the bottom may have the design of a thick circular ring enclosing a thinner circular disk. An outer radius of the circular ring may correspond to the total radius of the bottom. An inner radius of the circular ring may correspond to the outer radius of the circular disk.

In an embodiment, the can comprises a safety vent for enabling pressure relief. Thereby, an uncontrolled explosion of the capacitor in case of an overpressure may be prevented. The safety vent may be configured to burst when the pressure approaches a critical value. The safety vent may comprise a weak spot, for example, one or more grooves. The safety vent may be located in the can bottom.

In particular, the safety vent may be located in the first area. The safety vent may not extend into the second area. The thickness of the first area may be chosen such that the opening mechanism of the safety vent is facilitated. The thickness of the second area may not affect the opening mechanism of the safety vent. This allows the thickness of the second area to be optimized with respect to the mechanical stability of the can.

As an example, the safety vent may comprise at least one groove. The groove may be stamped in the can. The safety vent may be visible both at an inner surface of the bottom and at an outer surface of the bottom. In particular, the groove may be located both at an inner surface and at an outer surface. Inside the groove, the thickness of the bottom may be locally reduced. In particular, the safety vent may have a third thickness being smaller than the first thickness.

In an embodiment, the can may be configured such that at high pressure, the safety vent enables pressure relief before bulging of the first area results in the first area protruding beyond the second area. In particular, during an increase of pressure inside the can, the first area may bulge outwards. The safety vent may be configured to open before the bulging of the first area leads to a bulging of the overall can. Thereby, an overall deformation of the bottom may be prevented.

In an embodiment, the can may be configured to be mounted to a mounting device. As an example, the can may be configured to be mounted such that a gap is present between the second area and the mounting device. The gap may enable the release of gas, which is discharged from the safety vent.

In an embodiment, the can bottom may not comprise a safety vent. A safety vent may be located at a lateral side of the can, for example. In a further embodiment, the can may not comprise any safety vent.

According to an embodiment, the bottom of the can comprises a base material having a high resistance to pressure. In this case, the bulging or elongation of the can bottom can be reduced not only by the geometric design of the can bottom but additionally or alternatively by the material properties of the can bottom. As an example, the can bottom comprises the aluminum alloy AlSi₁MgMn. The lateral area of the can may comprise the same base material as the can bottom.

In a further aspect, embodiments of the present invention relate to a can for an electrolytic capacitor, wherein the can comprises a bottom and wherein the base material of the bottom comprises the aluminum alloy AlSi₁MgMn. The can may comprise any functional and structural characteristics of the can described above. The can may comprise a lateral area. The lateral area may comprise the same base material as the bottom. The lateral area may be integral with the bottom. The aluminum alloy AlSi₁MgMn has a higher resistance to pressure than standard base materials. Thereby, a deformation of the can, in particular bulging or elongation, in case of high pressure inside the can, may be reduced.

According to a further aspect of embodiments of the present invention, an electrolytic capacitor comprises a can and a capacitor element mounted in the can. The capacitor may comprise any functional and structural characteristics of one of the cans described above. As an example, the can bottom may comprise a first area and a second area, wherein the first area forms a recess in an outer surface of the bottom. Additionally or alternatively, the can bottom may comprise the aluminum alloy AlSi₁MgMn as a base material.

According to a further aspect of embodiments of the present invention, an assembly of an electrolytic capacitor and a mounting device is disclosed. The capacitor may comprise any functional and structural characteristics as described above. The mounting device may be a circuit board or a bus bar, for example. The capacitor is mounted on the mounting device such that a gap is present between the second area and the mounting device. As an example, the second area may not be in direct contact with any other devices. The electrolytic capacitor may be mechanically fixed and/or electrically connected to the mounting device. The gap may enable the release of gas, which is discharged from the safety vent, to the outside of the assembly. In such a mounting arrangement, gaps in the second area are not required to enable a release of gas.

In a further embodiment, the electrolytic capacitor and the mounting device may be arranged such that the second area directly contacts the mounting device. In this case, a safety vent may not be provided in the can bottom. Instead, the safety vent may be located in a lateral side of the can.

The present disclosure comprises several aspects of an invention. Every feature described with respect to the can and/or the capacitor is also disclosed herein with respect to the other aspect, even if the respective feature is not explicitly mentioned in the context of the specific aspect.

### BRIEF DESCRIPTION OF THE DRAWINGS

Further features, refinements and expediencies become apparent from the following description of the exemplary embodiments in connection with the figures.

FIG. 1 shows a sectional view of a can for an electrolytic capacitor;

FIG. 2 shows a view of an outer surface of the bottom of the can of FIG. 1;

FIG. 3 shows a view of an inner surface of the bottom of the can of FIG. 1;

FIG. 4 shows a schematic sectional view of a capacitor; and

FIG. 5 shows a diagram of bulging versus pressure.

Similar elements, elements of the same kind and identically acting elements may be provided with the same reference numerals in the figures.

### DETAILED DESCRIPTION OF ILLUSTRATIVE EMBODIMENTS

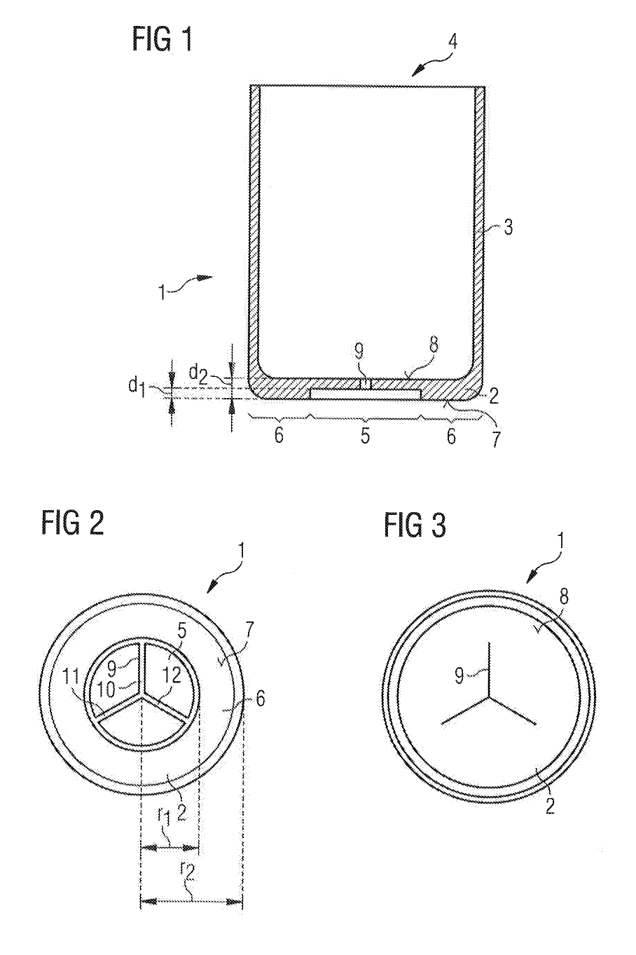

FIG. 1 shows a can 1 for an electrolytic capacitor in a schematic sectional view.

The can 1 has the shape of a circular cylinder. The can 1 comprises a bottom 2 closing the can 1 at a first side, a lateral area 3 and an opening 4 at a second side opposite the first side. During operation of the capacitor, the opening 4 may be closed by a cover member. The can 1 may be used for housing a capacitor element impregnated with a liquid electrolyte.

The can 1 may be formed in one piece. The can 1 may comprise a metal. As an example, the can 1 may comprise aluminium. The base material composition may be an aluminium alloy, for example.

In order to increase the mechanical stability of the can 1, the bottom 2 comprises a specific geometrical design. The bottom 2 comprises a first area 5 and a second area 6, wherein the first area 5 is recessed relative to the second area 6 at the outer surface 7. In particular, the first area 5 and the second area form a stepped geometry at the outer surface 7. At an inner surface 8 of the can bottom 2, the first area 5 may be non-discernible from the second area 6. In other words, the bottom 2 may have a plain inner surface 8.

The thickness d₂ of the second area 6 is larger than the thickness d₁ of the first area 5. As an example, the second thickness d₂ may be at least 1.5 times the first thickness d₁. The increased thickness d₂ of the second area 6 leads to an increase of the overall stability of the can bottom 2 and to a decrease of overall component bulging. Nevertheless, the first area 5 enables a certain amount of component bulging and, thereby reduces the overall mechanical stress.

Due to the recessed arrangement of the first area 5 relative to the second area 6, bulging of the first area 5 may not lead to a large total bulging of the can bottom 2, because the bulging occurs within the outer dimensions set by the second area 6. Preferably, the first area 5 is recessed sufficiently, such that it does not protrude beyond the outer surface of the second area 6 even in case of high pressure inside the can 1. The second area 6 may not show large bulging due to its increased thickness.

The second area 6 is arranged nearer to the lateral edge of the bottom 2 than the first area 5. In particular, the first area 5 may form a central part of the bottom 2. The second area 6 may fully enclose the first area 5.

FIG. 2 shows a view from the outside on the bottom 2 of the can 1, i.e., on the outer surface 7 of the bottom 2. As can be seen in FIG. 2, the second area 6 may have the shape of a circular ring. As an example, an outer radius r₂ of the circular ring may correspond to the radius of the can bottom 2. As an example, the radius of the can bottom 2 may be in a range of 10 mm to 60 mm.

The first area 5 may have the shape of a circular disk, which may be located inside the second area 6, in particular, the circular ring. The second area 6 fully encircles the first area 5, i.e., without any gaps in the second area 6. The radius of the circular disk may correspond to the inner radius r₁ of the circular ring. The inner radius r₁ depends on the intended opening pressure of the safety vent. The second area 6 extends in an area of the bottom 2, which is not covered by the lateral area 3.

The can 1 may comprise a safety vent 9 located in the bottom 2. The safety vent 9 enables controlled pressure relief. The safety vent 9 may enable a discharge of the gas when the inner pressure approaches a critical value. Thereby, an uncontrolled explosion of the capacitor may be prevented. As an example, the safety vent 9 may be designed to burst in case of a critical pressure. Bulging of the first area 5 may occur well before the safety vent 9 provides the pressure relief function. The safety vent 9 may be configured to open before bulging of the first area 5 leads to a protrusion of the first area 5 beyond the second area 6.

The safety vent 9 may be located in the first area 5. The total surface of the first area 5 is much larger than the safety vent 9. The thickness d₁ of the first area 5 is chosen such that the opening mechanism of the safety vent 9 is enabled and depends on the intended opening pressure of the safety vent 9. The thickness d₂ of the second area 6 can be optimized in respect of bulging, because the safety vent 9 does not extend into the second area 6.

The safety vent 9 may be formed by three equiangular arranged grooves 10, 11, 12. Other shapes, for example, a shape of a cross, a star or a “Z” may be equally possible. As an example, the safety vent 9 may be stamped in the bottom 2.

In the shown embodiment, the safety vent 9 extends to the edge of the first area 5. In particular, the length of the grooves 10, 11, 12 corresponds to the radius r of the first area 5. In further embodiments, the safety vent 9 may not extend up to the edge of the first area 5.

FIG. 3 shows a view from the inside of the can 1 on the bottom 2 of the can 1, i.e., on the inner surface 8 of the bottom 2. The inner surface 8 is plain, apart from the safety vent 9. From inside the can 1, the first area 5 is not discernible from the second area 6. The safety vent 9 is visible from inside and from outside the can 1. For enabling gas discharged from the safety vent 9 to be released to the outside in a mounted arrangement of the can 1, the can 1 may be configured to be mounted such that a gap is present between the second area 6 and a mounting device.

Alternatively or additionally to the outside stepped geometry described above, the material of the can 1, in particular of the can bottom 2 may have a high resistance to pressure. In this case, bulging of the can bottom 2 can be kept at a low level. As an example, the base material may comprise the alloy EN AW-6082 (AlSi₁MgMn). When using this alloy, the bulging resistivity may additionally increase by 20% for the same geometry in comparison to the base material EN AW-1050A (Al99,5).

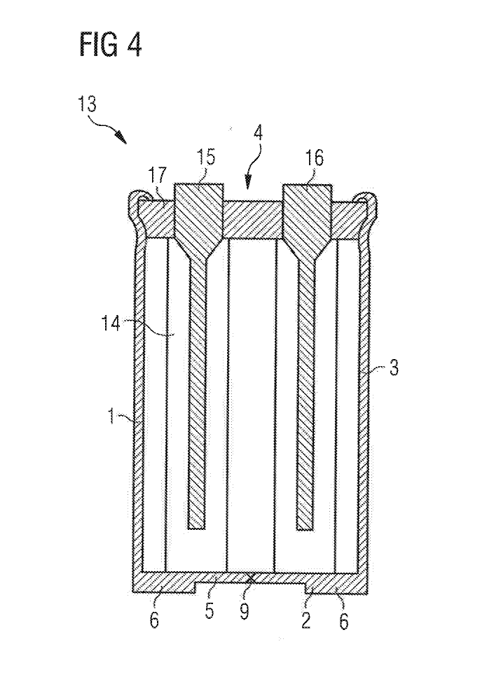

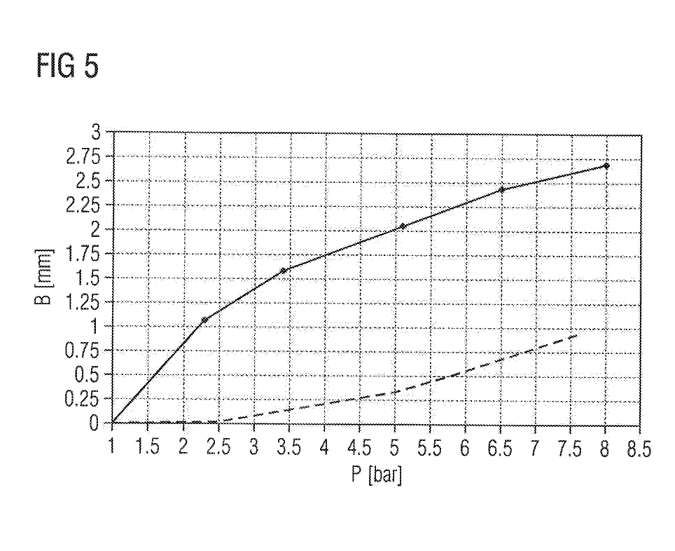

FIG. 4 shows an electrolytic capacitor 13. The capacitor 13 comprises a can 1 as described above. A capacitor element 14 is mounted in the can 1. The capacitor element 14 comprises a wound shape. The capacitor element 14 may comprise foils, in particular aluminium foils. The capacitor element 14 may be impregnated with a liquid electrolyte.

The capacitor 13 comprises terminals 15, 16 for electrically connecting the capacitor 13. The terminals 15, 16 may be configured as screw-type terminals.

The opening 4 of the can 1 is closed by a cover member 17. The cover member 17 may have the shape of a disc. The cover member 17 may seal the can 1. The cover member 17 may comprise a rubber material or another elastic material. The terminals 15, 16 are lead through the cover member 17.

FIG. 5 shows a diagram of total bulging B of the can bottom 2 versus pressure p inside a can 1 for two different designs.

The solid line shows bulging for a standard flat bottom design with the base material EN AW-1050A. The dashed line shows bulging for a reverse stepped geometry according to FIG. 1 with the base material EN AW-6082. As can be clearly seen from the diagram, the mechanical stability of the can expressed as bulging is considerably increased due to the geometrical changes and the changes in the base material.

1-18. (canceled)

19. A can for an electrolytic capacitor comprising:
a bottom comprising a first area and a second area,
wherein the first area is recessed relative to the second area at an outer surface of the bottom of the can.

20. The can of claim 19, wherein the first area has a first thickness and the second area has a second thickness, and wherein the second thickness is greater than the first thickness.

21. The can of claim 20, wherein the second thickness is at least 1.5 times the first thickness.

22. The can of claim 19, wherein the first area is plain with the second area at an inner surface of the bottom.

23. The can of claim 19, further comprising a safety vent for enabling pressure relief, wherein the safety vent is located in the first area.

24. The can of claim 23, wherein the safety vent comprises at least one groove.

25. The can of claim 23, wherein the safety vent enables pressure relief before bulging of the first area results in the first area protruding beyond the second area when high pressure builds up inside the can.

26. The can of claim 19, wherein the bottom does not comprise a safety vent for enabling pressure relief.

27. The can of claim 19, wherein the second area laterally encloses the first area.

28. The can claim 19, wherein the second area encloses the first area without any gaps.

29. The can of claim 19, wherein the first area has a shape of a circular disc.

30. The can of claim 29, wherein the second area has a shape of a circular ring.

31. The can of claim 19, wherein a geometry of the first and second areas are such that bulging of the first area does not result in an overall bulging of the can.

32. The can of claim 19, wherein the can is configured to be mounted to a mounting device such that a gap is located between the second area and the mounting device.

33. The can of claim 19, wherein the can comprises AlSi₁MgMn.

34. An electrolytic capacitor comprising:
the can according claim 19; and
a capacitor element mounted in the can.

35. An assembly comprising:
the electrolytic capacitor according to claim 19; and
a mounting device,
wherein the electrolytic capacitor is mounted on the mounting device, and
wherein a gap is located between the second area and the mounting device such that gas discharged from a safety vent is enabled to be released through the gap.

36. A can for an electrolytic capacitor comprising:
a bottom,
wherein a base material of the bottom comprises AlSi₁MgMn.

37. An electrolytic capacitor comprising:
the can according to claim 36; and
a capacitor element mounted in the can.

38. An assembly comprising:
the electrolytic capacitor according to claim 36; and
a mounting device,
wherein the electrolytic capacitor is mounted on the mounting device, and
wherein a gap is located between the second area and the mounting device such that gas discharged from a safety vent is enabled to be released through the gap.
